(19) United States
(12) Patent Application Publication
(10) Pub. No.: US 2026/0204843 A1
(43) Pub. Date: Jul. 16, 2026

(54) CONNECTOR ASSEMBLY

(71) Applicant: Japan Aviation Electronics Industry, Limited, Tokyo (JP)

(72) Inventor: Yusuke OBATA, Tokyo (JP)

(21) Appl. No.: 19/364,692

(22) Filed: Oct. 21, 2025

(30) Foreign Application Priority Data
Jan. 14, 2025 (JP) 2025-004528

(51) Int. Cl. H01R 13/641

(52) U.S. Cl. CPC H01R 13/641

(57) ABSTRACT

A connector assembly includes a first connector having a first fitting detection terminal and a second connector having a second fitting detection terminal, when a fitting operation starts, a pressing portion of a second housing of the second housing makes contact with a pressed portion of a spring portion of the first fitting detection terminal to cause an elastic deformation of a spring body, whereby the second connector advances without making contact a second contact point of the second connector with a first contact point of the first connector, and when the fitting operation is completed, the pressing portion passes the pressed portion of the spring portion to release the elastic deformation of the spring body, whereby the second contact point makes contact with the first contact point, and the second fitting detection terminal is electrically connected to the first fitting detection terminal.

### BACKGROUND OF THE INVENTION

The present invention relates to a connector assembly, particularly to a connector assembly having a fitting detection mechanism for electrically detecting the fitting state of a pair of connectors.

As a connector assembly having such a fitting detection mechanism, JP 2019-79703 A discloses a connector assembly in which a second connector 3 is fitted to a first connector 2 mounted on a circuit board 1, as shown in FIG. 40.

The first connector 2 includes a first housing 2A and a plurality of first contacts 2B held by the first housing 2A, while the second connector 3 includes a second housing 3A, a plurality of second contacts 3B held by the second housing 3A, and an electrically conductive half-fitting detection member 3C held by the second housing 3A and having a pair of arms.

When the second connector 3 starts to be inserted into a second connector accommodating portion 2C of the first housing 2A, as shown in FIG. 41, in a half-fitting state where a projecting portion 3E of an elastically deforming portion 3D of the second housing 3A makes contact with an edge portion 2D of the first housing 2A, the plurality of second contacts 3B make contact with and are electrically connected to the plurality of first contacts 2B, and at the same time, since the projecting portion 3E of the elastically deformed portion 3D makes contact with the edge portion 2D of the first housing 2A, the elastically deforming portion 3D is elastically deformed so as to allow the pair of arms of the half-fitting detection member 3C to make contact with a pair of second contacts 3B.

Thus, the pair of second contacts 3B are short-circuited via the half-fitting detection member 3C, and further, a pair of first contacts 2B of the first connector 2 electrically connected to the pair of second contacts 3B are also short-circuited.

When insertion of the second connector 3 into the second contact accommodating portion 2C further advances, as shown in FIG. 42, the projecting portion 3E of the elastically deforming portion 3D of the second housing 3A passes the edge portion 2D of the first housing 2A, and the elastically deforming portion 3D elastically returns, whereby the position of the second connector 3 with respect to the first connector 2 is locked, and the fitting between the first connector 2 and the second connector 3 is completed. In addition, due to the elastic return of the elastically deforming portion 3D, the contact between the pair of arms of the half-fitting detection member 3C and the pair of second contacts 3B is eliminated, so that the short-circuiting between the pair of first contacts 2B of the first connector 2 is also eliminated.

Therefore, by monitoring whether the pair of first contacts 2B of the first connector 2 are short-circuited, the fitting state between the first connector 2 and the second connector 3 can be detected. That is, when the pair of first contacts 2B are short-circuited, it is detected that the second connector 3 is in the half-fitting state with respect to the first connector 2.

However, as shown in FIG. 41, at the time when the half-fitting state is detected due to the short-circuiting between the pair of first contacts 2B of the first connector 2, the projecting portion 3E of the elastically deforming portion 3D of the second housing 3A does not pass the edge portion 2D of the first housing 2A, and the position of the second connector 3 with respect to the first connector 2 is not locked yet; nevertheless, the plurality of second contacts 3B already make contact with and are electrically connected to the plurality of first contacts 2B.

Therefore, when the second connector 3 receives a force exerted in the direction in which the second connector 3 is released from the first connector 2, the second connector 3 is pulled out from the first connector 2, and when a current flows between the plurality of first contacts 2B and the plurality of second contacts 3B of the second connector 3 in the half-fitting state, the current is blocked by pulling out of the second connector 3 from the first connector 2, disadvantageously.

### SUMMARY OF THE INVENTION

The present invention has been made to overcome the above problems associated with the prior art and aims at providing a connector assembly that can reliably detect the fitting after completion of the fitting.

A connector assembly according to the present invention comprises a first connector and a second connector that are fitted to each other along a fitting direction such that a first contact of the first connector and a second contact of the second connector are electrically connected to each other, wherein
the first connector includes
   a first housing in which a second connector accommodating portion is formed,
   the first contact held by the first housing, and
   a first fitting detection terminal held by the first housing and having a spring portion exposed to the second connector accommodating portion,
the second connector includes
   a second housing having a pressing portion projecting in a first direction orthogonal to the fitting direction,
   the second contact held by the second housing, and
   a second fitting detection terminal held by the second housing and having a second contact point exposed in the first direction,
the spring portion includes
   a spring body that is elastically deformable in the first direction,
   a first contact point set at a tip of the spring body, and
   a pressed portion joined to the spring body,
when a fitting operation between the first connector and the second connector starts while the second housing is accommodated into the second connector accommodating portion, the pressing portion of the second housing makes contact with the pressed portion of the spring portion to cause an elastic deformation of the spring body, whereby the second connector advances while the second contact point does not make contact with the first contact point, and
when the fitting operation between the first connector and the second connector is completed, the pressing portion of the second housing passes the pressed portion of the spring portion to release the elastic deformation of the spring body, whereby the second contact point makes contact with the first contact point, and the second fitting detection terminal is electrically connected to the first fitting detection terminal.

### BRIEF DESCRIPTION OF THE DRAWINGS

FIG. 1 is a perspective view showing a connector assembly of an embodiment before fitting.

FIG. 2 is an exploded view of a first connector in the connector assembly of the embodiment.

FIG. 3 is a perspective view showing a first housing of the first connector.

FIG. 4 is a front view showing the first housing of the first connector.

FIG. 5 is a side view showing the first contact of the first connector.

FIG. 6 is a perspective view showing a first fitting detection terminal of the first connector.

FIG. 7 is a side view showing the first fitting detection terminal of the first connector.

FIG. 8 is a front view showing the first fitting detection terminal of the first connector.

FIG. 9 is a cross-sectional side view showing the first connector mounted on a circuit board.

FIG. 10 is a cross-sectional plan view showing the first connector mounted on the circuit board.

FIG. 11 is an exploded view of a second connector in the connector assembly of the embodiment.

FIG. 12 is a perspective view showing a second housing of the second connector.

FIG. 13 is a side view showing the second housing of the second connector.

FIG. 14 is a perspective view showing a second contact of the second connector connected to an electric wire.

FIG. 15 is a perspective view showing a second fitting detection terminal of the second connector.

FIG. 16 is a cross-sectional side view showing the second connector.

FIG. 17 is a cross-sectional plan view showing the second connector.

FIG. 18 is a side view showing the second connector.

FIG. 19 is a plan view showing the connector assembly in a state where the second connector is aligned with the first connector.

FIG. 20 is a cross-sectional side view showing the connector assembly in a state where a leading end of a fit lock portion of the second housing makes contact with the first housing due to a fitting operation between the first connector and the second connector.

FIG. 21 is a partial cross-sectional plan view showing a positional relation between a pressed portion of a spring portion of the first fitting detection terminal and a pressing portion of the second housing at the same timing as that in FIG. 20.

FIG. 22 is a partial cross-sectional plan view showing a positional relation between a first contact point of the first fitting detection terminal and a second contact point of the second fitting detection terminal at the same timing as that in FIG. 20.

FIG. 23 is a cross-sectional side view showing the connector assembly in a state where the fit lock portion of the second housing starts to be pressed into a second connector accommodating portion of the first housing due to the fitting operation between the first connector and the second connector.

FIG. 24 is a partial cross-sectional plan view showing a positional relation between the pressed portion of a spring portion of the first fitting detection terminal and a pressing portion of the second housing at the same timing as that in FIG. 23.

FIG. 25 is a partial cross-sectional plan view showing a positional relation between a first contact point of the first fitting detection terminal and a second contact point of the second fitting detection terminal at the same timing as that in FIG. 23.

FIG. 26 is a cross-sectional side view showing the connector assembly in a state where the fit lock portion of the second housing is pressed in the second connector accommodating portion of the first housing due to the fitting operation between the first connector and the second connector.

FIG. 27 is a partial cross-sectional plan view showing a positional relation between the pressed portion of the spring portion of the first fitting detection terminal and the pressing portion of the second housing at the same timing as that in FIG. 26.

FIG. 28 is a partial cross-sectional plan view showing a positional relation between the first contact point of the first fitting detection terminal and the second contact point of the second fitting detection terminal at the same timing as that in FIG. 26.

FIG. 29 is a cross-sectional side view showing the connector assembly immediately before the first connector and the second connector are fitted to each other.

FIG. 30 is a partial cross-sectional plan view showing a positional relation between a pressed portion of a spring portion of the first fitting detection terminal and a pressing portion of the second housing at the same timing as that in FIG. 29.

FIG. 31 is a partial cross-sectional plan view showing a positional relation between the first contact point of the first fitting detection terminal and the second contact point of the second fitting detection terminal at the same timing as that in FIG. 29.

FIG. 32 is a perspective view showing the connector assembly in a state where fitting between the first connector and the second connector is completed.

FIG. 33 is a cross-sectional side view showing the connector assembly at the same timing as that in FIG. 32.

FIG. 34 is a partial cross-sectional plan view showing a positional relation between a pressed portion of a spring portion of the first fitting detection terminal and a pressing portion of the second housing at the same timing as that in FIG. 32.

FIG. 35 is a partial cross-sectional plan view showing a positional relation between a first contact point of the first fitting detection terminal and a second contact point of the second fitting detection terminal at the same timing as that in FIG. 32.

FIG. 36 is a partial cross-sectional plan view showing the entire second fitting detection terminal at the same timing as that in FIG. 32.

FIG. 37 is a cross-sectional side view showing the connector assembly in a state where the second connector is pressed against the first connector after the fitting between the first connector and the second connector is completed.

FIG. 38 is a partial cross-sectional plan view showing a positional relation between a pressed portion of a spring portion of the first fitting detection terminal and a pressing portion of the second housing at the same timing as that in FIG. 37.

FIG. 39 is a partial cross-sectional plan view showing a positional relation between a first contact point of the first fitting detection terminal and a second contact point of the second fitting detection terminal at the same timing as that in FIG. 37.

FIG. 40 is a cross-sectional view showing a conventional connector assembly before fitting.

FIG. 41 is a cross-sectional view showing the conventional connector assembly in a half-fitting state.

FIG. 42 is a cross-sectional view showing the conventional connector assembly in a fitting completion state.

### DETAILED DESCRIPTION OF THE INVENTION

An embodiment of the invention is described below based on the accompanying drawings.

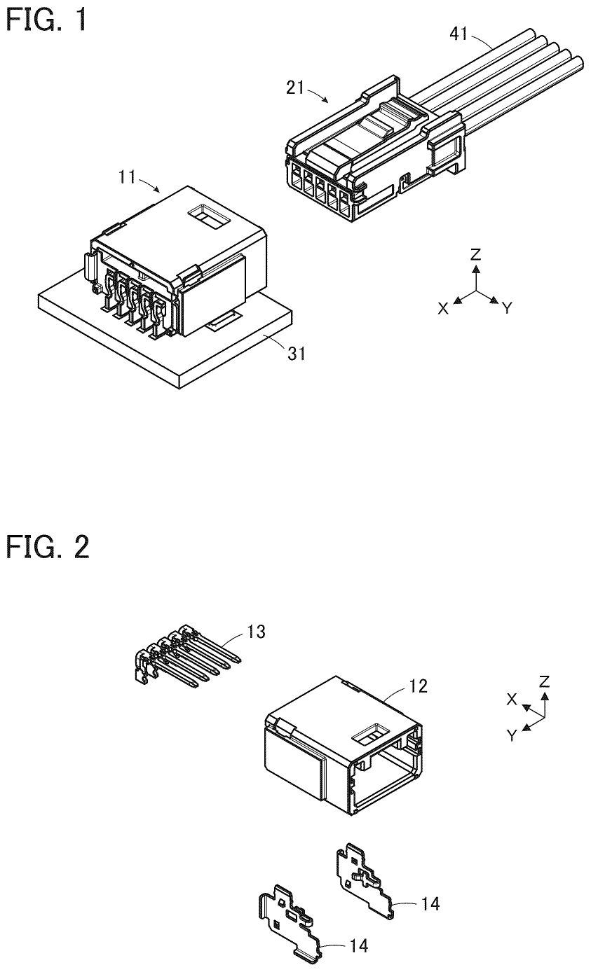

FIG. 1 shows a connector assembly according to the embodiment before fitting. The connector assembly includes a first connector 11 and a second connector 21. The first connector 11 is mounted on a circuit board 31, and a plurality of electric wires 41 being aligned are connected to the second connector 21. When the second connector 21 is linearly slid relatively to the first connector 11, the first connector 11 and the second connector 21 are fitted to each other, whereby the electric wires 41 are electrically connected to an electric circuit of the circuit board 31.

For convenience, a direction from the second connector 21 toward the first connector 11 is referred to as “+X direction,” a direction in which the electric wires 41 are aligned “Y direction (first direction),” and a direction perpendicular to the circuit board 31, that is, a direction orthogonal to an XY plane “Z direction (second direction).”

The X direction represents a fitting direction in fitting between the first connector 11 and the second connector 21.

FIG. 2 shows an exploded view of the first connector 11. The first connector 11 includes a first housing 12, a plurality of first contacts 13 held by the first housing 12, and a pair of first fitting detection terminals 14 held by the first housing 12.

The first contacts 13 are aligned in the Y direction and, in this state, held by the first housing 12. The pair of first fitting detection terminals 14 have shapes symmetrical with each other with respect to an XZ plane and are separately held at the +Y directional end portion and the −Y directional end portion of the first housing 12.

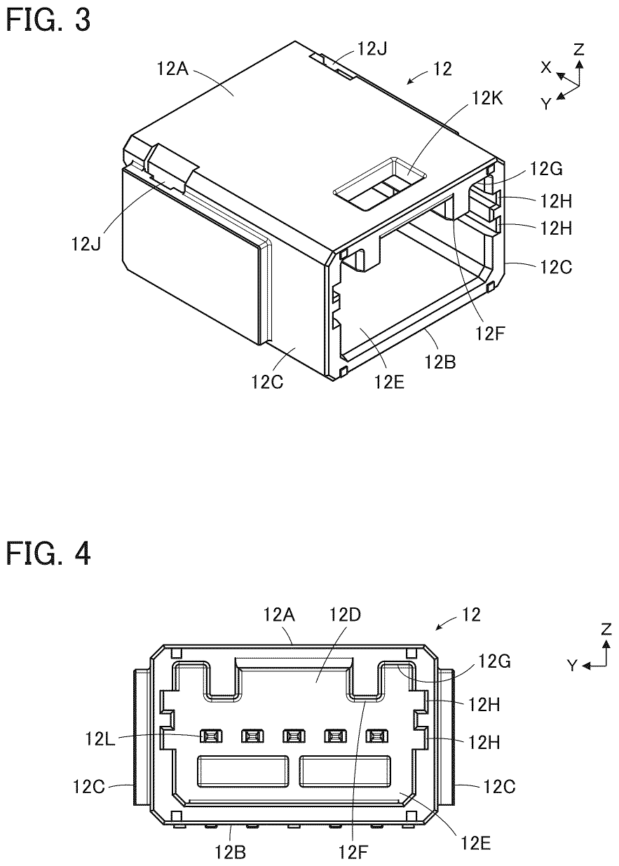

As shown in FIGS. 3 and 4, the first housing 12 is formed of an insulating material and has a box-like shape opening toward the −X direction. The first housing 12 is composed of a top plate portion 12A and a bottom plate portion 12B that extend along an XY plane, a pair of lateral plate portions 12C that extend along an XZ plane, and a back plate portion 12D that extends along a YZ plane, and a second connector accommodating portion 12E is formed inside the first housing 12.

Near the +Y directional end portion and the −Y directional end portion of the top plate portion 12A, a pair of protrusion portions 12F are separately formed to protrude in the −Z direction toward the inside of the second connector accommodating portion 12E and extend in the X direction, and between these protrusion portions 12F and the pair of lateral plate portions 12C, a pair of second connector guiding grooves 12G are separately formed to open in the −Z direction and extend in the X direction.

In addition, two projection guiding grooves 12H are formed in each of the pair of side plate portion 12C at a position adjacent to the second connector guiding groove 12G on the −Z direction side, the two projection guiding grooves 12H opening in the Y direction toward the second connector accommodating portion 12E and extending in the X direction. The two projection guiding grooves 12H extend in the X direction in parallel to each other with a predetermined gap therebetween in the Z direction.

Further, near the +X directional end portion of each of the pair of lateral plate portions 12C, a press-fitting hole 12J is formed to open toward the +Z direction. The press-fitting hole 12J is used to hold the first fitting detection terminal 14 in the first housing 12.

Near the −X directional end portion of the upper plate portion 12A, a fit lock receiving portion 12K of recess shape is formed to penetrate the upper plate portion 12A in the Z direction.

In addition, the back plate portion 12D is provided with a plurality of contact holding holes 12L that penetrate the back plate portion 12D in the X direction and are used to hold the plurality of first contacts 13 to the first housing 12.

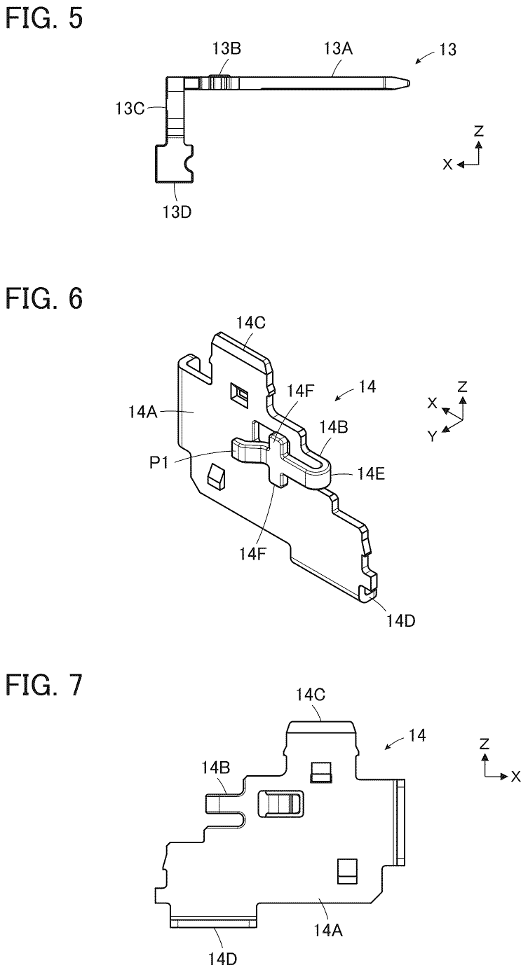

As shown in FIG. 5, the first contact 13 is made of a conductive material such as metal and includes a contact body 13A of pin shape extending in the X direction, a holding portion 13B disposed to be adjacent to the contact body 13A on the +X direction side thereof, a bending portion 13C bent from the +X direction side of the holding portion 13B toward the −Z direction, and a connection portion 13D disposed at the −Z directional end portion of the bending portion 13C.

The holding portion 13B is used to hold the first contact 13 to the first housing 12 by being press-fitted into the contact holding hole 12L of the back plate portion 12D of the first housing 12.

The connection portion 13D is connected to the circuit board 31 when the first connector 11 is mounted on the circuit board 31.

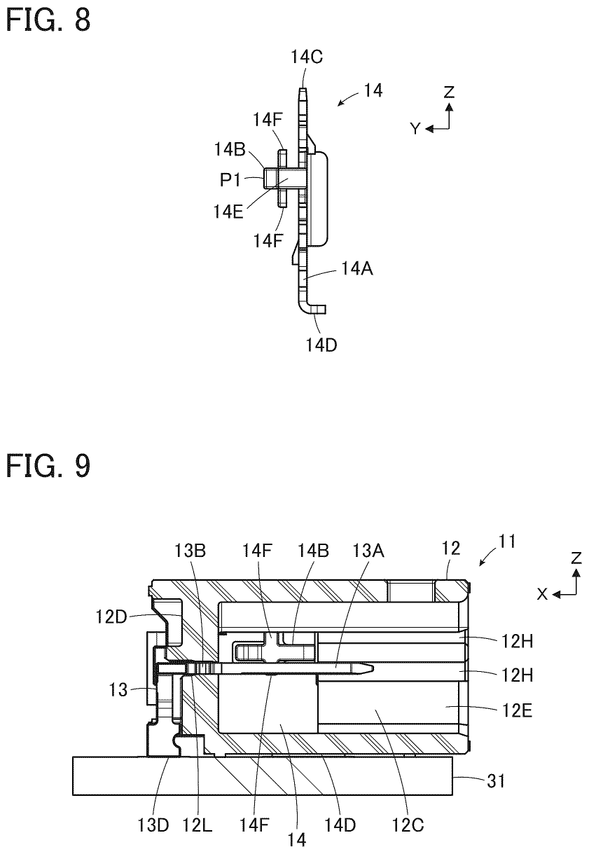

FIGS. 6 to 8 show the first fitting detection terminal 14 disposed on the −Y direction side of the pair of first fitting detection terminals 14. The first fitting detection terminal 14 is formed of a single metal sheet having conductivity and being cut in a predetermined shape and bent, and includes a flat plate portion 14A extending along an XZ plane, a spring portion 14B formed by bending a portion of the flat plate portion 14A, a holding portion 14C disposed at the +Z directional end portion of the flat plate portion 14A, and a connection portion 14D disposed at the −Z directional end portion of the flat plate portion 14A.

The spring portion 14B includes a spring body 14E that is curved in the −Y direction at a position away from the flat plate portion 14A in the −X direction and bent back to the +X direction in a U shape so as to be elastically deformable in the Y direction. A pair of pressed portions 14F projecting in the Z direction are joined to the opposite sides in the Z direction of a folding-back portion of the spring body 14E, and further, a first contact point P1 is set on a surface, facing in the +Y direction, of the folding-back portion at a +X directional end of the spring body 14E. The pair of pressed portions 14F are disposed at positions distanced from each other in the Z direction, and the first contact point P1 is situated between the pair of pressed portions 14F in the Z direction.

When the holding portion 14C is press-fitted into the press-fitting hole 12J of the first housing 12, the first fitting detection terminal 14 is held by the first housing 12 in the state where the spring portion 14B is exposed to the second connector accommodating portion 12E.

The connection portion 13D is connected to the circuit board 31 when the first connector 11 is mounted on the circuit board 31.

Of the pair of first fitting detection terminals 14, the first fitting detection terminal 14 disposed on the +Y direction side has the same configuration as that of the first fitting detection terminal 14 on the −Y direction side as shown in FIGS. 6 to 8 except that it has a shape symmetrical with the first fitting detection terminal 14 on the −Y direction side with respect to an XZ plane.

The pair of first fitting detection terminals 14 are separately held at the pair of lateral plate portions 12C of the first housing 12, and the plurality of first contacts 13 are held by the back plate portion 12D of the first housing 12, whereby the first connector 11 is assembled.

FIG. 9 shows the first connector 11 mounted on the circuit board 31. The spring portion 14B of the first fitting detection terminal 14 is exposed to the second connector accommodating portion 12E. Here, the pair of pressed portions 14F formed at the spring portion 14B are spaced from each other in the Z direction by a distance equal to the predetermined gap in the Z direction between the two projection guiding grooves 12H formed at the lateral plate portion 12C of the first housing 12, and as shown in FIG. 9, the pair of pressed portions 14F are situated on the extension lines, in the +X direction, of the two projection guiding grooves 12H within the second connector accommodating portion 12E.

In addition, the contact body 13A and the holding portion 13B of the first contact 13 are inserted from the +X direction into the contact holding hole 12L of the back plate portion 12D of the first housing 12, the holding portion 13B is held at the back plate portion 12D, and the contact body 13A projects to the inside of the second connector accommodating portion 12E.

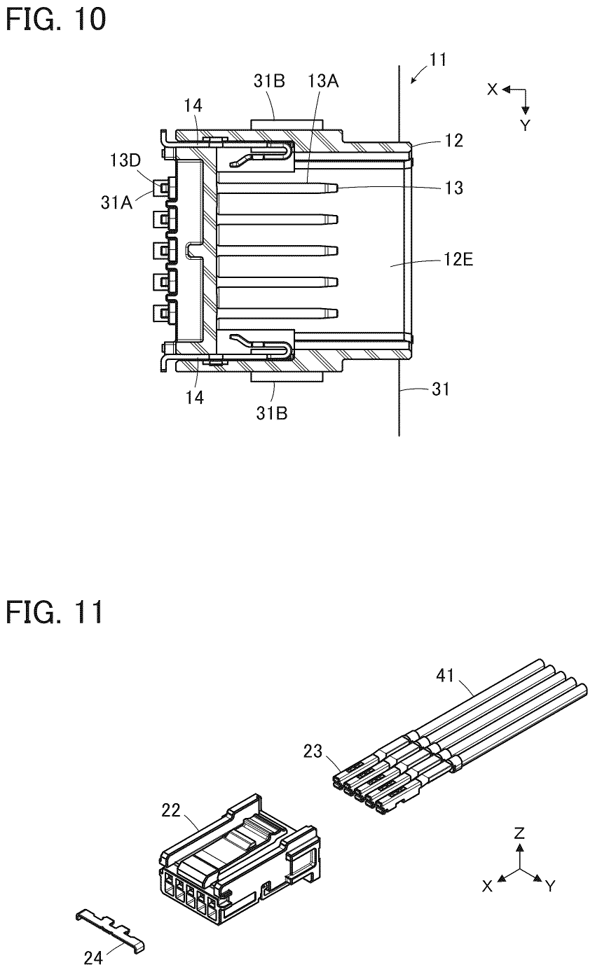

As shown in FIG. 10, the connection portions 13D of the plurality of first contacts 13 are connected to a plurality of conductive pads 31A of the circuit board 31, and the connection portions 14D of the pair of first fitting detection terminals 14 are connected to a pair of conductive pads 31B for fitting detection of the circuit board 31.

FIG. 11 shows an exploded view of the second connector 21. The second connector 21 includes a second housing 22, a plurality of second contacts 23 held by the second housing 22, and a second fitting detection terminal 24 held by the second housing 22.

A plurality of electric wires 41 are connected to the plurality of second contacts 23, and the plurality of second contacts 23 are held by the second housing 22 while being aligned in the Y direction. The second fitting detection terminal 24 is held at the +X directional end portion of the second housing 22.

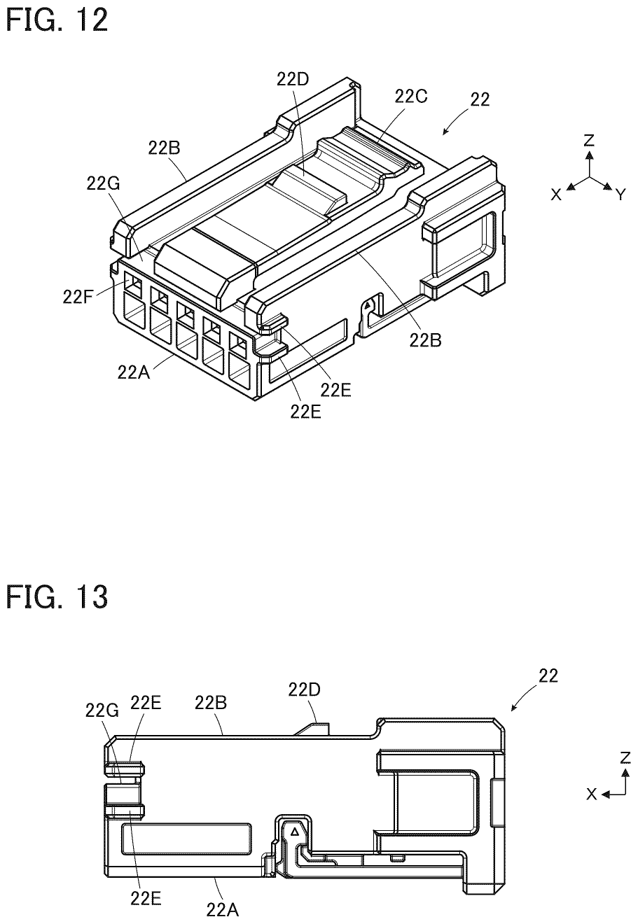

As shown in FIGS. 12 and 13, the second housing 22 is formed of an insulating material and has a housing body 22A of substantially cuboid shape. The top portion of the housing body 22A is provided with a pair of wall portions 22B projecting in the +Z direction separately at the +Y directional end portion and the −Y directional end portion of the housing body 22A and extending in the X direction, and an operating portion 22C of cantilever shape that is disposed between the pair of wall portions 22B and is elastically deformable in the Z direction. The operating portion 22C is provided with a fit lock portion 22D projecting in the +Z direction.

In addition, at the +X direction end portion of the housing body 22A, a pair of projections 22E projecting in the +Y direction and extending in the X direction are formed at the +Y directional side portion of the housing body 22A.

Similarly, at the +X directional end portion of the housing body 22A, a pair of projections 22E projecting in the −Y direction and extending in the X direction are formed at the −Y directional side portion of the housing body 22A.

It should be noted that when the second connector 21 is fitted to the first connector 11, the projection 22E constitutes a “pressing portion” for pressing the pressed portion 14F of the spring portion 14B of the first fitting detection terminal 14 shown in FIG. 6.

The pair of projections 22E above are spaced from each other in the Z direction by a distance equal to the predetermined gap in the Z direction between the two projection guiding grooves 12H formed at the lateral plate portion 12C of the first housing 12 shown in FIG. 3.

In addition, the spacing distance in the Z direction between the pair of projections 22E is set to be larger than the Z directional width of the spring body 14E in the spring portion 14B of the first fitting detection terminal 14 shown in FIG. 6 and be smaller than the distance from the +Z directional end portion of the pressed portion 14F on the +Z direction side to the −Z directional end portion of the pressed portion 14F on the −Z direction side.

As shown in FIG. 12, at the +X directional end portion of the housing body 22A, a plurality of first contact insertion holes 22F are formed to be aligned in the Y direction.

Further, at the +X directional end portion of the housing body 22A, a second fitting detection terminal holding portion 22G is formed to extend in the Y direction from the +Y directional end portion to the −Y directional end portion of the housing body 22A on the +Z direction side of the plurality of first contact insertion holes 22F.

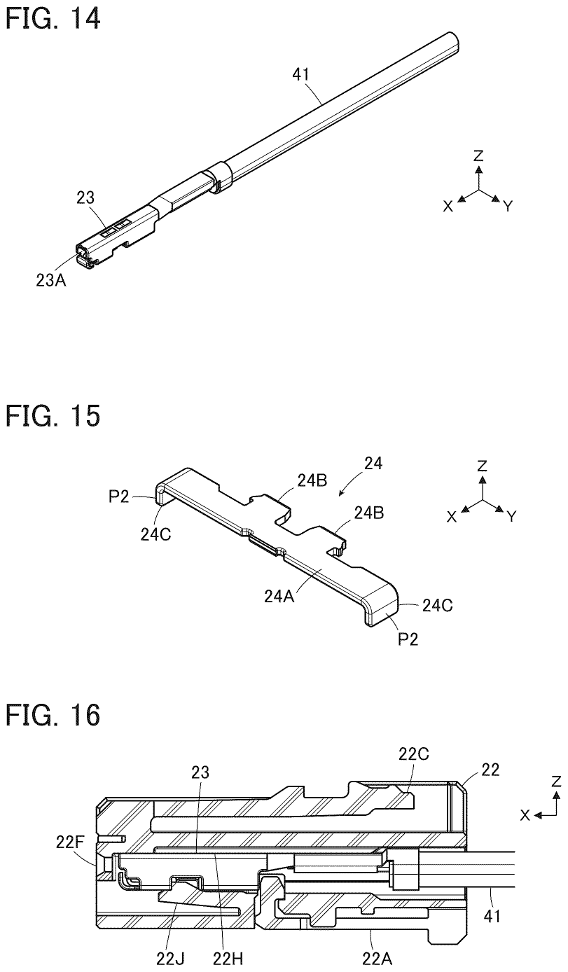

As shown in FIG. 14, the second contact 23 is made of a conductive material such as metal and has a socket shape extending in the X direction, and a first contact insertion hole 23A is formed at the +X directional end portion of the second contact 23. When the second connector 21 is fitted to the first connector 11, the contact body 13A of the first contact 13 shown in FIG. 5 is inserted into the first contact insertion hole 23A of the corresponding second contact 23.

The corresponding electric wire 41 is connected to the −X directional end portion of the second contact 23.

As shown in FIG. 15, the second fitting detection terminal 24 is made of a conductive material such as metal and includes a terminal body portion 24A of flat plate shape extending in the Y direction along an XY plane, a pair of holding portions 24B projecting from the terminal body portion 24A toward the −X direction, and a pair of bending portions 24C bent in the −Z direction separately at the +Y directional end portion and the −Y directional end portion of the terminal body portion 24A.

Of the pair of bending portions 24C, the bending portion 24C on the +Y direction side has a second contact point P2 set on the surface thereof facing in the +Y direction, and the bending portion 24C on the −Y direction side has a second contact point P2 set on the surface thereof facing in the −Y direction.

The plurality of second contacts 23 and the second fitting detection terminal 24 are held by the second housing, whereby the second connector 21 is assembled.

As shown in FIG. 16, a plurality of second contact accommodating portions 22H communicating with the plurality of first contact insertion holes 22F are formed inside the housing body 22A, and the second contact 23 to which the electric wire 41 is connected is inserted from the −X direction in the corresponding second contact accommodating portion 22H and accommodated thereinto. The second contact 23 is configured such that it does not come off the second contact accommodating portion 22H in the −X direction when a lance 22J formed at the housing body 22A is caught.

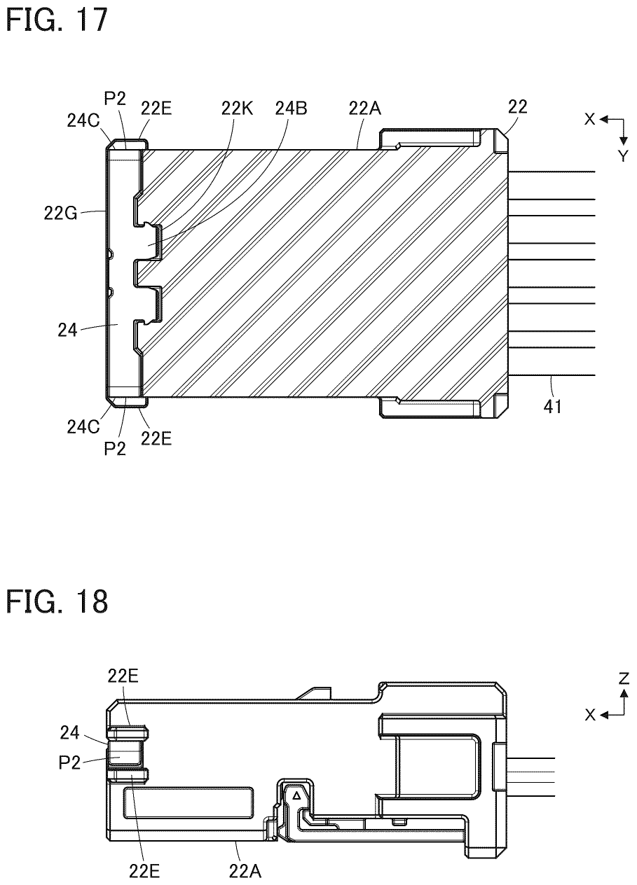

As shown in FIG. 17, the pair of holding portions 24B are press-fitted in press-fitting holes 22K of the housing body 22A from the +X direction, whereby the second fitting detection terminal 24 is held by the second fitting detection terminal holding portion 22G. Here, the second fitting detection terminal 24 extends in the Y direction from the +Y directional end portion to the −Y directional end portion of the housing body 22A, and the pair of second contact points P2 separately set at the pair of bending portions 24C of the second fitting detection terminal 24 are exposed toward the +Y direction or the −Y direction from the housing body 22A.

It should be noted that the distance between the pair of second contact points P2 in the Y direction is set to be larger than the gap in the Y direction between the first contact points P1 of the pair of first fitting detection terminals 14 of the first connector 11 shown in FIG. 10.

Further, as shown in FIG. 18, each of these second contact points P2 is situated in the Z direction between the pair of projections 22E projecting in the Y direction from the side portion of the housing body 22A at the +X directional end portion of the housing body 22A.

In addition, when the second connector 21 is accommodated in the second connector accommodating portion 12E of the first connector 11, the pair of projections 22E are situated at Z directional positions on the +Z direction side and −Z direction side of the spring body 14E of the spring portion 14B of the first fitting detection terminal 14, and the second contact point P2 is situated at the same Z directional position as that of the first contact point P1 set at the spring body 14E.

The fitting operation between the first connector 11 and the second connector 21 that have such configurations will be described.

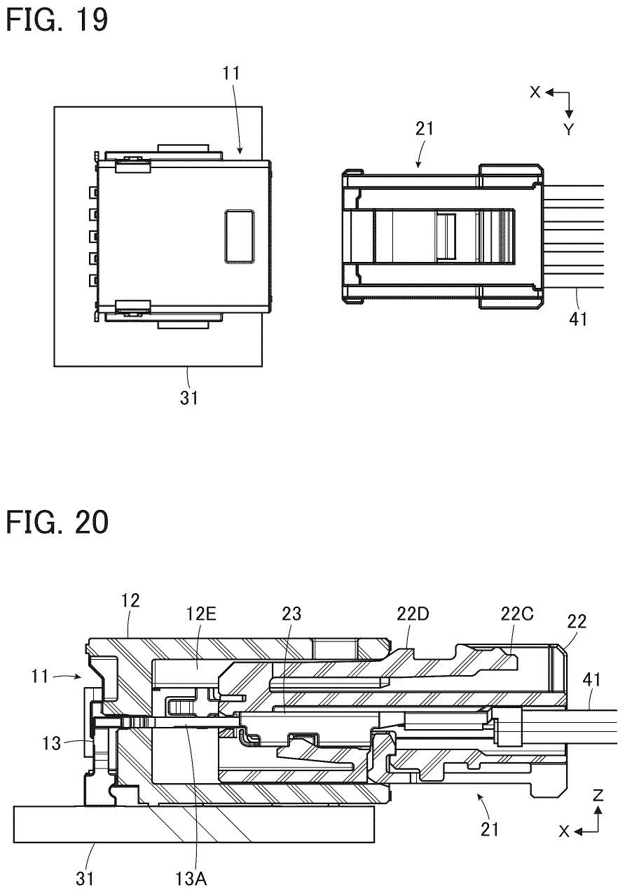

First, as shown in FIG. 19, the second connector 21 is aligned with the first connector 11 on the −X direction side thereof.

In this state, when the second connector 21 is moved in the +X direction toward the first connector 11, the pair of wall portions 22B of the second housing 22 are inserted into and thus guided by the pair of second connector guiding grooves 12G of the first housing 12 shown in FIG. 3, and as shown in FIG. 20, the +X directional portion of the second housing 22 of the second connector 21 is inserted into the second connector accommodating portion 12E of the first housing 12 of the first connector 11. It should be noted that the projections 22E formed to protrude on opposite side portions in the Y direction of the second housing 22 are each inserted into the corresponding projection guiding groove 12H of the first housing 12 and moved in the +X direction.

FIG. 20 shows a state where the +X directional end of the fit lock portion 22D formed to protrude in the operating portion 22C of the second housing 22 makes contact with the −X directional edge portion of the second connector accommodating portion 12E of the first housing 12. At this time, the −X direction side portion of the contact body 13A of the first contact 13 is inserted into the second contact 23, and electrical connection between the first contact 13 and the second contact 23 starts.

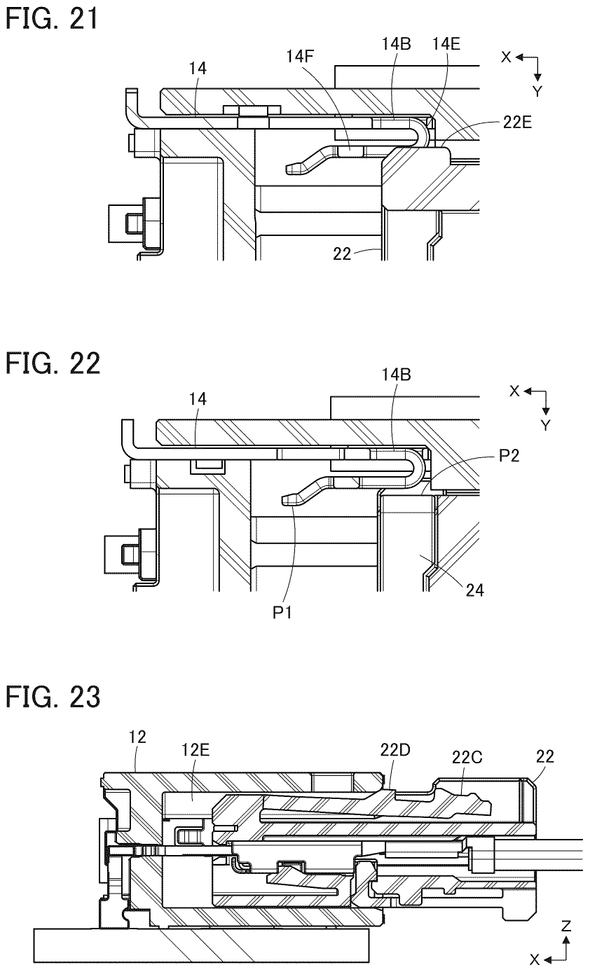

At this time, as shown in FIG. 21, the pair of projections 22E at each Y directional end portion of the second housing 22 are situated separately on the +Z direction side and the −Z direction side of the spring body 14E of the spring portion 14B of the first fitting detection terminal 14 across the spring body 14E and situated at the X directional position where the projections 22E do not reach the pair of pressed portions 14F yet.

Therefore, the spring body 14E is in the initial state without being elastically deformed. Note that, as shown in FIG. 22, the second contact point P2 of the second fitting detection terminal 24 is situated on the −X direction side of the first contact point P1 of the first fitting detection terminal 14 and does not make contact with the first contact point P1.

When the second housing 22 is inserted further into the second connector accommodating portion 12E of the first housing 12, as shown in FIG. 23, the fit lock portion 22D of the second housing 22 is pressed against the −X directional edge portion of the second connector accommodating portion 12E of the first housing 12, and the elastic deformation of the operating portion 22C in the −Z direction starts.

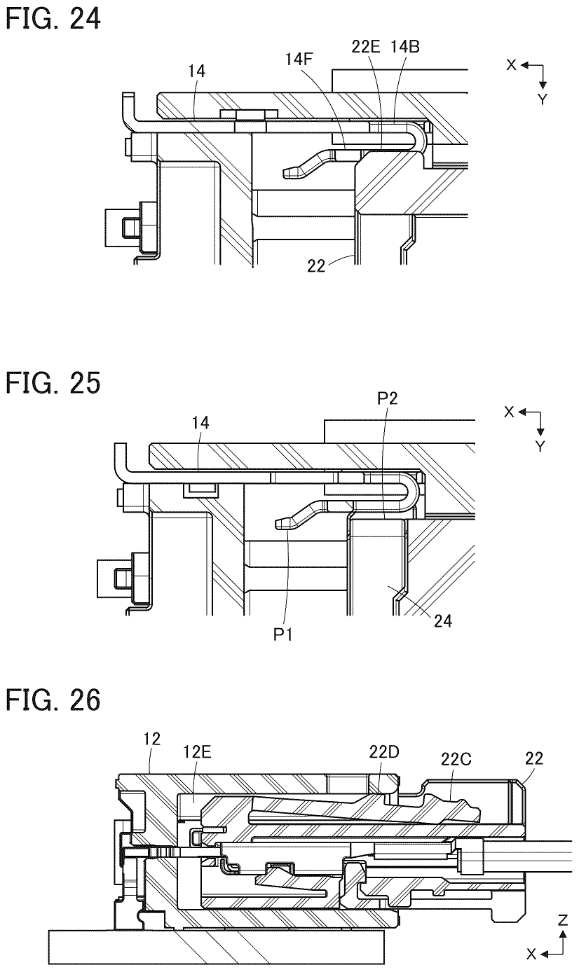

At this time, as shown in FIG. 24, the pair of projections 22E of the second housing 22 starts to make contact with the pair of pressed portions 14F of the spring portion 14B of the first fitting detection terminal 14.

However, as shown in FIG. 25, the second contact point P2 of the second fitting detection terminal 24 is still situated on the −X direction side of the first contact point P1 of the first fitting detection terminal 14 and does not make contact with the first contact point P1.

When the insertion of the second housing 22 into the second connector accommodating portion 12E of the first housing 12 further advances, as shown in FIG. 26, the operating portion 22C of the second housing 22 is further elastically deformed, and the fit lock portion 22D enters the second connector accommodating portion 12E of the first housing 12.

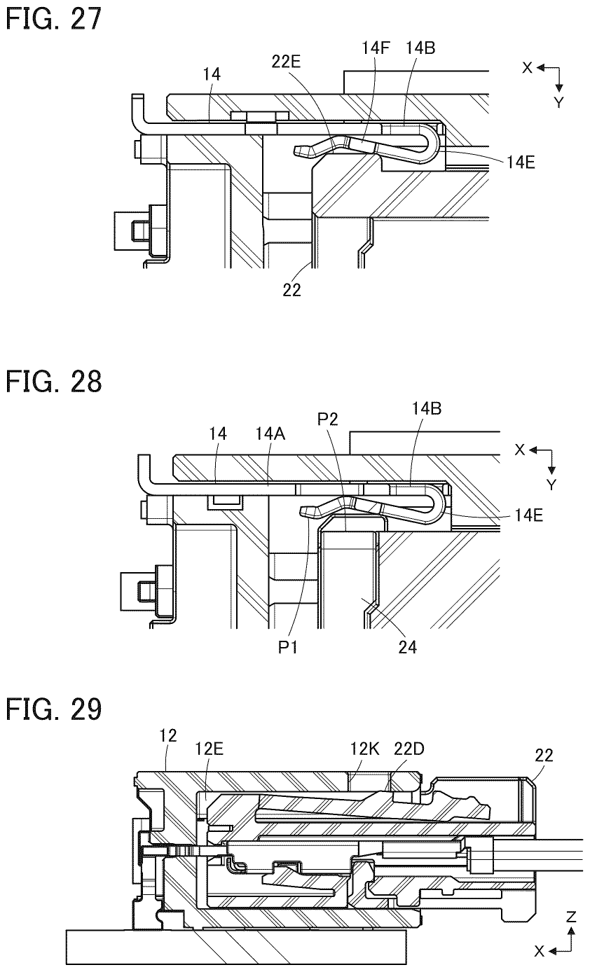

At this time, as shown in FIG. 27, the pair of projections 22E of the second housing 22 press the pair of pressed portions 14F of the spring portion 14B of the first fitting detection terminal 14 in the Y direction, whereby the spring body 14E of the spring portion 14B is elastically deformed.

Therefore, as shown in FIG. 28, the first contact point P1 set at the +X directional end portion of the spring body 14E is displaced so as to approach the flat plate portion 14A of the first fitting detection terminal 14, i.e., to separate from the second contact point P2 of the second fitting detection terminal 24 in the Y direction, and does not make contact with the second contact point P2.

With the further insertion of the second housing 22 into the second connector accommodating portion 12E of the first housing 12, as shown in FIG. 29, the fit lock portion 22D of the second housing 22 approaches the fit lock receiving portion 12K of the first housing 12.

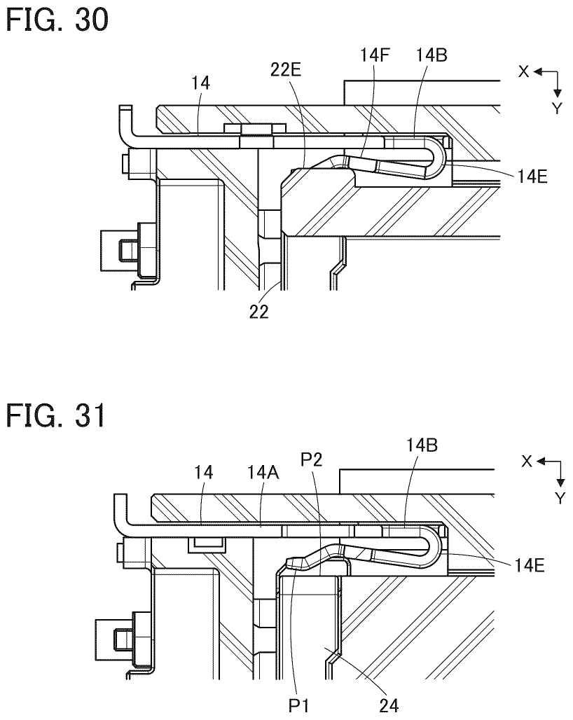

At this time, as shown in FIG. 30, the pair of projections 22E of the second housing 22 continue to press the pair of pressed portions 14F of the spring portion 14B of the first fitting detection terminal 14 in the Y direction, and the elastic deformation of the spring body 14E of the spring portion 14B is maintained.

Therefore, as shown in FIG. 31, while the second contact point P2 of the second fitting detection terminal 24 reaches the X directional position overlapping the first contact point P1 of the first fitting detection terminal 14, the first contact point P1 set at the +X directional end portion of the spring body 14E still does not make contact with the second contact point P2 while being kept to be displaced so as to approach the flat plate portion 14A of the first fitting detection terminal 14, i.e., to separate from the second contact point P2 of the second fitting detection terminal 24 in the Y direction.

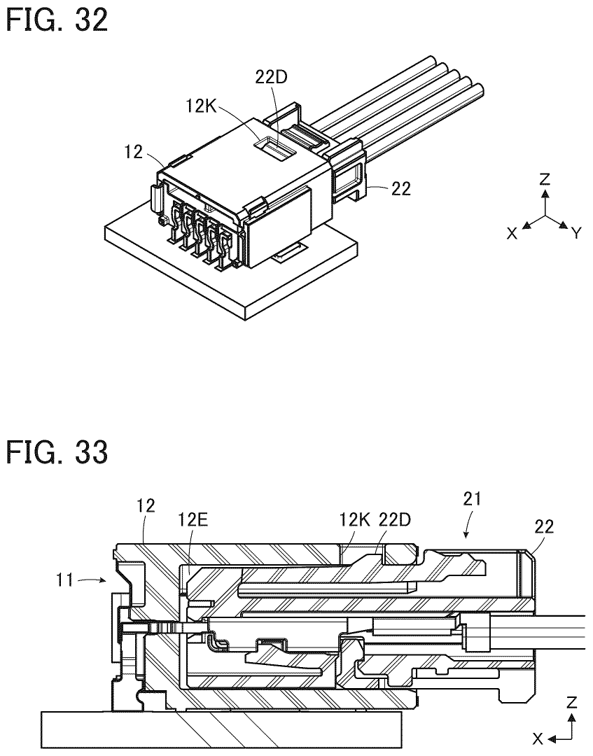

The insertion of the second housing 22 into the second connector accommodating portion 12E of the first housing 12 further advances, and as shown in FIGS. 32 and 33, the fit lock portion 22D of the second housing 22 is fitted in the fit lock receiving portion 12K of the first housing 12, whereby the fitting operation of the second connector 21 to the first connector 11 is completed.

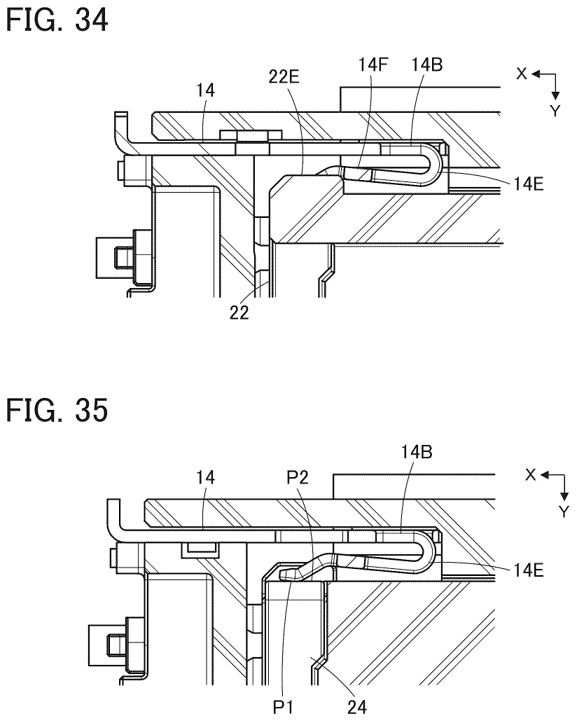

At this time, as shown in FIG. 34, the pair of projections 22E of the second housing 22 pass the pair of pressed portions 14F of the spring portion 14B of the first fitting detection terminal 14 and are situated on the +X direction side of the pressed portions 14F, whereby the elastic deformation of the spring body 14E of the spring portion 14B is released.

Therefore, as shown in FIG. 35, the first contact point P1 set at the +X directional end portion of the spring body 14E is pressed against the second contact point P2 of the second fitting detection terminal 24 due to the elastic force of the spring body 14E and thus makes contact with the second contact point P2. Consequently, the second fitting detection terminal 24 is electrically connected to the first fitting detection terminal 14.

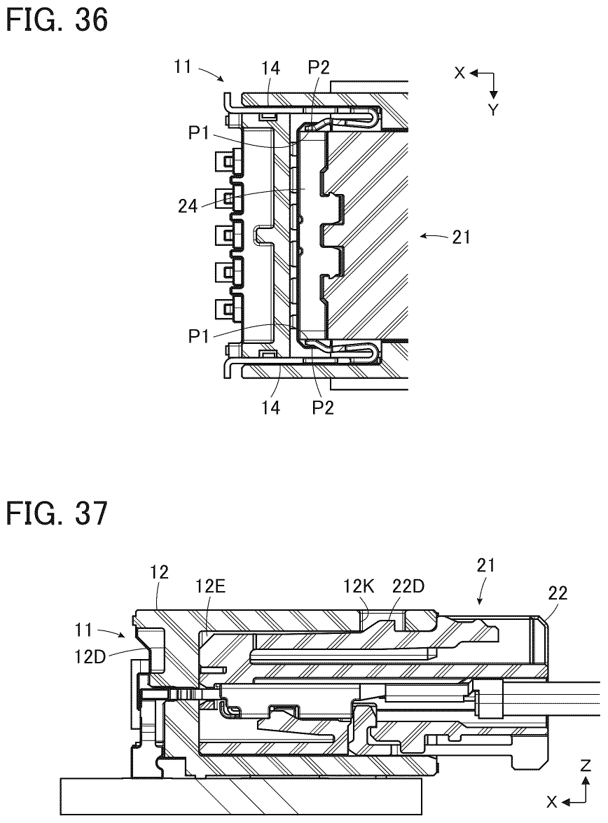

As shown in FIG. 36, the second contact point P2 set at the −Y directional end portion of the second fitting detection terminal 24 makes contact with the first contact point P1 of the first fitting detection terminal 14 disposed on the −Y direction side of the first connector 11, while the second contact point P2 set at the +Y directional end portion of the second fitting detection terminal 24 makes contact with the first contact point P1 of the first fitting detection terminal 14 disposed on the +Y direction side of the first connector 11.

Therefore, the pair of first fitting detection terminals 14 of the first connector 11 are electrically connected to each other via the second fitting detection terminal 24 of the second connector 21.

Here, since the connection portions 14D of the pair of first fitting detection terminals 14 are connected to the pair of conductive pads 31B for fitting detection of the circuit board 31 as shown in FIG. 10, by determining the electric conduction between the pair of conductive pads 31B in the circuit board 31, it can be confirmed that the first contact points P1 of the pair of first fitting detection terminals 14 of the first connector 11 make contact with the pair of second contact points P2 of the second fitting detection terminal 24 of the second connector 21.

That is, when electric conduction is established between the pair of conductive pads 31B of the circuit board 31, the completion of the fitting operation of the second connector 21 to the first connector 11 can be detected.

In particular, in the fitting operation of the second connector 21 to the first connector 11, the pair of second contact points P2 of the second fitting detection terminal 24 of the second connector 21 do not make contact with the first contact points P1 of the pair of first fitting detection terminals 14 of the first connector 11 until the fitting is completed, as shown in FIGS. 20 to 31.

Then, as shown in FIGS. 32 to 35, the fit lock portion 22D of the second housing 22 is fitted with the fit lock receiving portion 12K of the first housing 12, and the fitting of the second connector 21 to the first connector 11 is completed; at this point, the pair of second contact points P2 of the second fitting detection terminal 24 make contact with the first contact points P1 of the pair of first fitting detection terminals 14 for the first time.

Therefore, the fitting between the first connector 11 and the second connector 21 can be surely detected after the completion of the fitting.

Also after the fit lock portion 22D of the second housing 22 is fitted with the fit lock receiving portion 12K of the first housing 12 as a result of the insertion of the second housing 22 into the second connector accommodating portion 12E of the first housing 12, when the second connector 21 is pressed toward the first connector 11, as shown in FIG. 37, the +X directional end portion of the second housing 22 abuts the back plate portion 12D of the first housing 12.

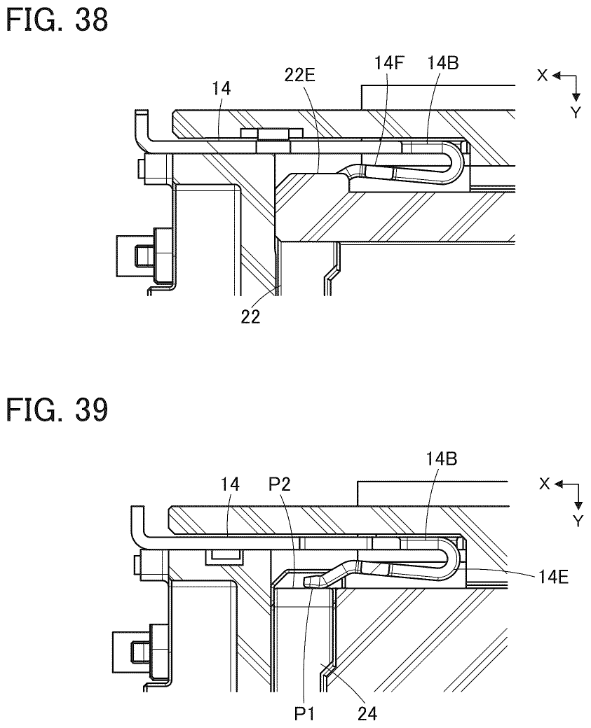

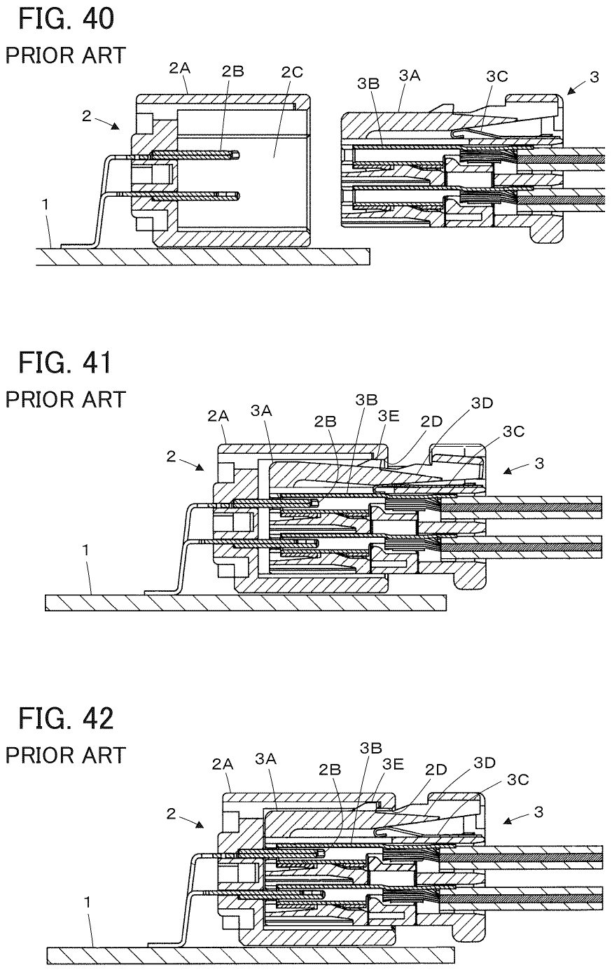

At this time, since the pair of projections 22E of the second housing 22 are situated on the +X direction side of the pair of pressed portions 14F of the spring portion 14B of the first fitting detection terminal 14 as shown in FIG. 38, the pair of pressed portions 14F are not pressed by the pair of projections 22E in the Y direction.

Therefore, as shown in FIG. 39, the first contact point P1 continues to press the second contact point P2 of the second fitting detection terminal 24 due to the elastic force of the spring body 14E, and the contact between the first contact point P1 and the second contact point P2 is maintained. That is, the electrically conducting state between the first fitting detection terminal 14 and the second fitting detection terminal 24 is maintained.

Even when a certain tensile force acting in the −X direction is applied to the second connector 21 from the fitting completion state shown in FIGS. 33 to 35 or the pressing state of the second connector 21 after the fitting completion shown in FIGS. 37 to 39, while the fit lock portion 22D of the second housing 22 is fitted with the fit lock receiving portion 12K of the first housing 12, the pair of pressed portions 14F of the first fitting detection terminal 14 are not pressed by the pair of projections 22E of the second housing 22, and the spring body 14E is not elastically compressed; thus, the contact between the first contact point P1 and the second contact point P2 is maintained. Therefore, the fitting state between the first connector 11 and the second connector 21 can be surely detected.

In order to release the fitting state between the first connector 11 and the second connector 21, it suffices if the fit lock portion 22D fitted in the fit lock receiving portion 12K of the first housing 12 is detached from the fit lock receiving portion 12K by pressing down the operating portion 22C of the second housing 22 of the second connector 21 in the −Z direction, and in this state, the second connector 21 is pulled out from the first connector 11 in the −X direction.

In the connector assembly according to the embodiment described above, in the fitting operation between the first connector 11 and the second connector 21, the pair of projections 22E spaced away from each other in the Z direction on the second housing 22 of the second connector 21 and press, in the Y direction, the pair of pressed portions 14F spaced away from each other in the Z direction on the first fitting detection terminals 14 of the first connector 11; however, it may be configured such that one projection 22E disposed on the second housing 22 presses one pressed portion 14F disposed at the first fitting detection terminal 14.

However, as in the embodiment described above, the pair of pressed portions 14F are disposed on opposite sides in the Z direction of the spring portion 14E of the first fitting detection terminal 14, and the pair of pressed portions 14F are pressed by the pair of projections 22E of the second housing 22; in this configuration, the spring body 14E can be elastically compressed in the Y direction without being tilted with respect to an XZ plane or without being twisted, so reliability of the contact between the first contact point P1 and the second contact point P2 is improved.

In addition, since the spring body 14E of the first fitting detection terminal 14 has a shape that curves in the +Y direction and bends back toward the +X direction in a U shape at a position away from the flat plate portion 14A toward the −X direction, i.e., toward the opening of the second connector accommodating portion 12E as shown in FIG. 6, a failure, for instance, the second housing 22 abuts the tip of the spring body 14E in the insertion of the second housing 22 into the second connector accommodating portion 12E can be prevented.

Further, since the spring portions 14B of the pair of first fitting detection terminals 14 are disposed inside the first housing 12 of the first connector 11 mounted on the circuit board 31, the user does not touch the spring portion 14B in the fitting operation, and highly reliable fitting detection can be performed.

It should be noted that in the connector assembly according to the invention, the number of the first contacts 13 and the number of the second contacts 23 are not limited to those in the illustrated embodiment, and it suffices if the first connector 11 and the second connector 21 have at least one first contact 13 and at least one second contact 23 connected to each other.

What is claimed is:

1. A connector assembly comprising a first connector and a second connector that are fitted to each other along a fitting direction such that a first contact of the first connector and a second contact of the second connector are electrically connected to each other, wherein
the first connector includes
a first housing in which a second connector accommodating portion is formed,
the first contact held by the first housing, and
a first fitting detection terminal held by the first housing and having a spring portion exposed to the second connector accommodating portion,
the second connector includes
a second housing having a pressing portion projecting in a first direction orthogonal to the fitting direction,
the second contact held by the second housing, and
a second fitting detection terminal held by the second housing and having a second contact point exposed in the first direction,
the spring portion includes
a spring body that is elastically deformable in the first direction,
a first contact point set at a tip of the spring body, and
a pressed portion joined to the spring body,
when a fitting operation between the first connector and the second connector starts while the second housing is accommodated into the second connector accommodating portion, the pressing portion of the second housing makes contact with the pressed portion of the spring portion to cause an elastic deformation of the spring body, whereby the second connector advances while the second contact point does not make contact with the first contact point, and
when the fitting operation between the first connector and the second connector is completed, the pressing portion of the second housing passes the pressed portion of the spring portion to release the elastic deformation of the spring body, whereby the second contact point makes contact with the first contact point, and the second fitting detection terminal is electrically connected to the first fitting detection terminal.

2. The connector assembly according to claim 1, wherein the spring portion includes a pair of the pressed portions separately disposed on opposite sides of the spring body in a second direction orthogonal to both the fitting direction and the first direction, and
the pressing portion includes a pair of projections corresponding to the pair of the pressed portions.

3. The connector assembly according to claim 1, wherein one of the first housing and the second housing includes a fit lock portion which is formed to project and is elastically displaceable,
another one of the first housing and the second housing includes a fit lock receiving portion of recess shape, and
when the fitting operation between the first connector and the second connector is completed, the fit lock portion is fitted in the fit lock receiving portion, whereby a fitting state between the first connector and the second connector is locked.

4. The connector assembly according to claim 1, wherein the first connector includes a pair of the first fitting detection terminals which are spaced from each other in the first direction and held by the first housing,
the second housing includes a pair of the pressing portions corresponding to the pair of the first fitting detection terminals,
the second fitting detection terminal extends along the first direction and has a pair of the second contact points separately disposed at opposite ends of the second fitting detection terminal in the first direction,
when the fitting operation between the first connector and the second connector starts, the pair of the pressing portions of the second housing separately make contact with the pressed portions of the spring portions of the pair of the first fitting detection terminals to elastically deform the spring bodies of the pair of the first fitting detection terminals, and
when the fitting operation between the first connector and the second connector is completed, the pair of the second contact points separately make contact with the first contact points of the pair of the first fitting detection terminals, and the second fitting detection terminal is electrically connected to each of the pair of the first fitting detection terminals.

5. The connector assembly according to claim 1, wherein the first connector is mounted on a circuit board, and
the first fitting detection terminal has a connection portion connected to a conductive pad of the circuit board.

6. The connector assembly according to claim 1, wherein the first connector includes a plurality of the first contacts,
the second connector includes a plurality of the second contacts, and
when the fitting operation between the first connector and the second connector is completed, the plurality of the first contacts and the plurality of the second contacts are electrically connected to each other.
